(19) United States
(12) Patent Application Publication
(10) Pub. No.: US 2016/0123185 A1
(43) Pub. Date: May 5, 2016

(54) METHOD AND A CIRCUIT FOR VENTILATING EQUIPMENT OF A TURBOJET BY THERMOELECTRICITY

(71) Applicant: SNECMA, Paris (FR)

(72) Inventors: Gwénolé Yann LE PACHE, Dammarie-les-Lys (FR); Lise Jeanine Léonie DOMECQ, Melun (FR)

(73) Assignee: SNECMA, Paris (FR)

(21) Appl. No.: 14/926,628

(22) Filed: Oct. 29, 2015

(30) Foreign Application Priority Data
Oct. 30, 2014 (FR) 1460426

(51) Int. Cl. F01D 25/12; F04D 25/08; F01D 15/08; F04D 29/58; F01D 5/02; F04D 25/06; F04D 29/32

(52) U.S. Cl. CPC F01D 25/12; F04D 25/0673; F04D 25/082; F04D 29/325; F04D 29/5806; F01D 5/02; F01D 15/08; F05D 2220/323; F05D 2260/221; F05D 2270/52

(57) ABSTRACT

The invention provides a method of ventilating equipment of a turbojet, the turbojet (10) having a cold zone (ZF) including a fan (14) upstream from a hot zone (ZC), the turbojet equipment (32) for ventilating being arranged in a ventilation space (30) available around the hot zone between a primary air stream passage (26) and a secondary air stream passage (28) of the turbojet, the method comprising taking ventilation air from one of the air stream passages in order to convey it to the ventilation space, and providing forced flow of the ventilation air by means of at least one electric fan (36) positioned inside the ventilation space and powered electrically by at least one thermoelectric generator (38) suitable for inducing a potential difference (ΔV) and positioned in a wall (40) between the ventilation space and the secondary air stream passage.

### BACKGROUND OF THE INVENTION

The present invention relates to the general field of ventilation of equipment located in the vicinity of the hot zone of a turbojet.

A turbojet has a large amount of auxiliary equipment. This comprises in particular the various accessories of the accessory gearbox (AGB) such as pumps for producing hydraulic energy, fuel supply, lubrication, electricity generators for producing electrical power, etc., together with the hydromechanical unit (HMU) that serves to control the servovalves used for metering the flow rate at which fuel is sent to the hydraulic actuators for actuating the variable geometry components of the turbojet and to the air valves of the engine air circuit.

Such equipment is sensitive to high temperatures and should therefore preferably be arranged in the vicinity of the cold zone of the turbojet, i.e. around its fan, in order to avoid any suffering of the reliability of the equipment from being subjected to high levels of thermal stress.

Unfortunately, for high bypass ratio turbojets, arranging equipment around the fan would lead to increasing the drag of such turbojets. It has thus become common practice to position some equipment in the vicinity of the hot zone of the turbojet. This hot zone is typically situated downstream from the cold zone (around the high-pressure body of the turbojet—also known as the “core”—comprising in particular the high-pressure compressor and the combustion chamber) where there is space available for housing turbojet equipment.

In order to limit the temperature to which the equipment is subjected while the turbojet is in operation, it is known to place heat shields around the high-pressure body of the turbojet and to ventilate the space in which the equipment is located by taking cold air coming from the fan.

Nevertheless, once the engine has stopped, cold air is no longer conveyed to the equipment for the purpose of ventilating it, even though the high-pressure body of the turbojet is still very hot and continues to radiate so that the temperature of the equipment rises before cooling very progressively. This phenomenon, commonly referred to as “soakback”, whereby the ambient temperature within the engine increases, can last for a long time after the engine has been stopped, and the peak temperature is generally reached several hours after stopping.

In an attempt to overcome that drawback, one solution consists in dimensioning the equipment so that it can withstand the temperatures that occur during this soakback phenomenon. Nevertheless, that solution is made ineffective by numerous additional pieces of equipment being incorporated in the space around the high-pressure body of the turbojet, which pieces of equipment are usually not designed to withstand such temperatures.

Another known solution consists in providing forced air ventilation through the space in which equipment is housed after the engine has stopped and until the temperature comes back down. Reference may be made in particular to Documents FR 2 955 896 and FR 2 955 897 which describe ventilation circuits using a variable speed fan that is controlled from the cockpit or the electronic computer of the turbojet and that is powered electrically by means of auxiliary power units (APUs), or else by the ground power supply unit that is provided by the airport, or indeed by the batteries of the airplane.

To operate, that solution thus requires one of the above-mentioned sources of electricity to be available for powering the fans after the engine has stopped. Unfortunately, when the engine is stopped, it is preferable for the airplane and thus the APU also to be switched off. Furthermore, for reasons of independence between systems, airplane manufacturers are generally reticent about supplying auxiliary energy to the engine when it is stopped. In addition, powering fans from the batteries of the airplane requires the batteries to be dimensioned accordingly, and that necessarily makes them heavier. Finally, taking power from the ground power supply unit is constraining from an operational point of view since it monopolizes the airplane, personnel, and equipment.

### OBJECT AND SUMMARY OF THE INVENTION

An object of the present invention is thus to provide a method and a circuit for actively ventilating equipment of a turbojet without presenting the above-mentioned drawbacks.

In accordance with the invention, this object is achieved by a method for the ventilation of equipment of a turbojet, the turbojet having a cold zone including a fan upstream from a hot zone, the turbojet equipment intended to be ventilated being arranged in a ventilation space available around the hot zone between a primary air stream passage and a secondary air stream passage of the turbojet, the method comprising taking ventilation air from one of the air stream passages in order to convey it to the ventilation space, and providing forced flow of said ventilation air by means of at least one electric fan positioned inside the ventilation space and powered electrically by a plurality of thermoelectric generators positioned inside a wall separating the ventilation space from the secondary air stream passage.

Correspondingly, the invention also provides a ventilation circuit for equipment of a turbojet, the turbojet having a cold zone including a fan upstream from a hot zone, the turbojet equipment intended to be ventilated being arranged in a ventilation space available around the hot zone between a primary air stream passage and a secondary air stream passage of the turbojet, the circuit comprising means for taking ventilation air from one of the air stream passages and for conveying it to the ventilation space, and at least one electric fan positioned inside the ventilation space and powered electrically by a plurality of thermoelectric generators positioned inside a wall separating the ventilation space from the secondary air stream passage.

The method of the invention can advantageously be implemented after the engine has stopped. After a stop, the temperature of the high-pressure body of the turbojet significantly exceeds the ambient temperature that exists inside the secondary air stream passage. A large temperature gradient is thus available between the high-pressure body and the secondary air stream passage. The method and the circuit of the invention are thus remarkable in that they use this temperature gradient as a source of energy for providing forced flow of ventilation air through the ventilation space in which the equipment is located. Specifically, the thermoelectric generators are devices that convert heat (here in the form of the temperature gradient available between the high-pressure body and the secondary stream passage) into electricity for powering a fan that is positioned inside the ventilation space.

Powered electrically in this way, the fan enables the ventilation space to be ventilated, and thus enables the equipment to be cooled. The temperature gradient between the high-pressure body and the secondary air stream passage decreases correspondingly. Since the electrical power produced by the thermoelectric generators is proportional to the temperature gradient to which they are subjected, the reduction in the gradient leads to a reduction in the power that is produced and thus to a drop in the ventilation of the equipment. The fan thus comes to a stop on its own when the temperature gradient between the high-pressure body and the secondary air stream passage reaches a certain threshold. At this stage, the ventilation space has been cooled sufficiently and has reached temperature equilibrium with the secondary air stream passage.

The method and the circuit of the invention thus have the advantage of effectively regulating temperature in the ventilation space containing the equipment without it being necessary to provide electricity from outside the turbojet. The ventilation circuit of the invention is thus totally independent and self-regulating without any need to have recourse to a temperature sensor or to any other control system. Finally, the ventilation circuit is reliable and simple to implement.

The electric fan can be stopped as soon as the temperature inside the ventilation space becomes less than a predetermined threshold temperature. Correspondingly, the circuit may include means for stopping the electric fan when the temperature inside the ventilation space drops below a predetermined threshold.

This characteristic seeks to stop ventilation of the equipment before temperature equilibrium is established between the ventilation space and the secondary air stream passage. This makes it possible to limit overuse of the ventilation circuit when there is no need to bring the temperature of the equipment to such a low temperature.

The operation of the electric fan may be monitored in order to detect any malfunction. Correspondingly, the circuit may include means for detecting possible malfunction of the fan.

The electric fan may be electrically powered during at least one stage of operation of the turbojet so as to ventilate the equipment in flight.

Each thermoelectric generator of the ventilation circuit may comprise a plurality of semiconductor elements having thermoelectric properties and connected to two conductive plates, each plate being covered in a substrate forming electrical insulation, one of the substrates being placed beside the secondary air stream passage, and the other substrate being placed beside the ventilation space.

The invention also provides a turbojet including a ventilation circuit as defined above.

### BRIEF DESCRIPTION OF THE DRAWING

Other characteristics and advantages of the present invention appear from the following description made with reference to the accompanying drawings, which show an embodiment having no limiting character. In the figures:

FIG. 1 is a diagrammatic section view of a turbojet fitted with a ventilation circuit of the invention;

FIG. 2 is a diagrammatic view of a thermoelectric generator used in the FIG. 1 ventilation circuit; and

FIG. 3 is a functional view of the FIG. 1 ventilation circuit.

### DETAILED DESCRIPTION OF THE INVENTION

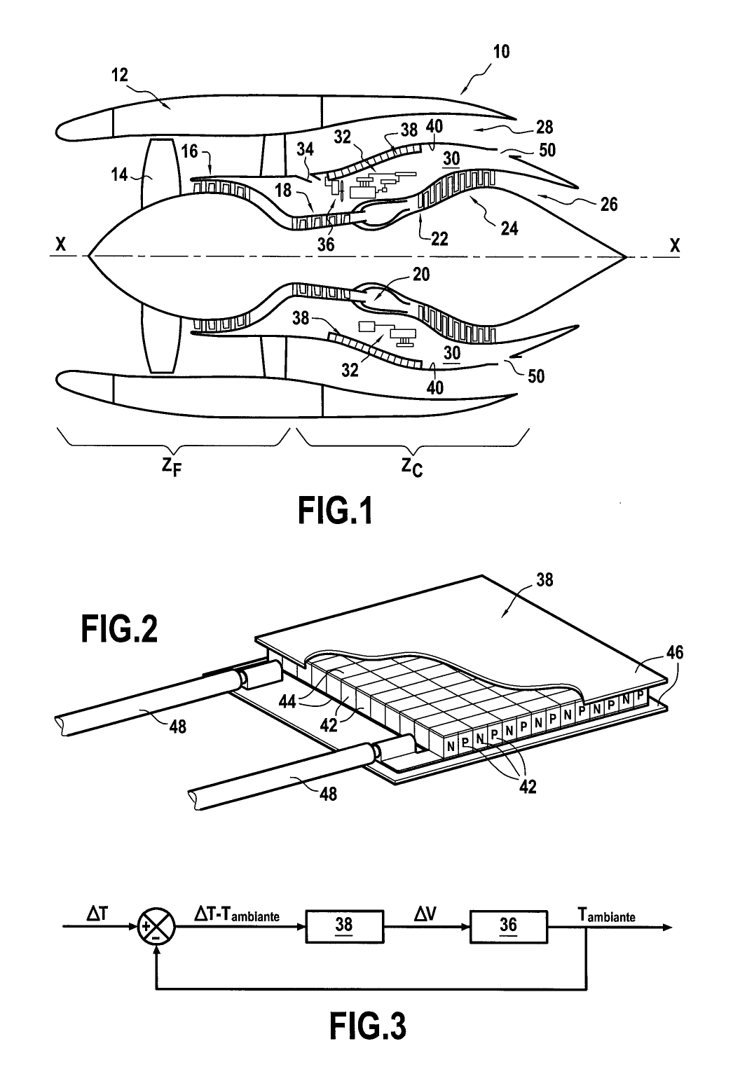

FIG. 1 is a diagrammatic longitudinal section view of an aircraft turbojet 10 of the bypass and double spool type, which turbojet is surrounded by a nacelle 12. In known manner, the turbojet 10 comprises from upstream to downstream: a fan 14, a low-pressure compressor 16, a high-pressure compressor 18, a combustion chamber 20, a high-pressure turbine 22, and a low-pressure turbine 24, which are all centered on a longitudinal axis X-X.

The turbojet 10 also has a primary air stream passage 26 (for a hot stream) and a secondary air stream passage 28 (for a cold stream) that is formed around the primary stream passage.

The turbojet 10 also has a cold zone Z_{F} (including in particular the fan 14 and the low-pressure compressor 16) upstream from a hot zone Z_{C} (corresponding to the high-pressure body and including in particular the high-pressure compressor 18 and the combustion chamber 20).

A ventilation space 30 is defined within the hot zone Z_{C} for receiving various pieces of equipment 32 of the turbojet (such as the accessories of AGB, the HMU, etc.). In the example of FIG. 1, this ventilation space is situated around the high-pressure compressor 18 and the combustion chamber 20 and it is in communication with the outside of the turbojet (i.e. it is subjected to ambient pressure).

Since the ventilation space 30 is situated level with the hot zone Z_{C} of the turbojet, the equipment 32 arranged inside it is exposed to the high temperatures that exist in the hot zone.

Thus, in order to ventilate the equipment 32 so as to limit its rise in temperature, the invention makes provision for providing a ventilation circuit that takes ventilation air from the secondary air stream passage 28 downstream from the fan 14 in order to take it to the inside of the ventilation space 30.

In the invention, this ventilation circuit comprises in particular at least one scoop 34 opening out into the secondary air stream passage 28 downstream from the fan 14 and leading into the ventilation space 30 where the equipment 32 is located.

The ventilation circuit of the invention also has at least one electric fan 36 arranged inside the ventilation space 30 downstream from the scoop 34 and upstream from the equipment 32 that is to be ventilated.

The function of the fan 36 is to maintain forced flow of ventilation air through the ventilation space 30 after the turbojet has stopped, or even while it is still in operation, for the purpose of lowering the temperature of the equipment 32.

The ventilation circuit of the invention also includes a plurality of thermoelectric generators 38 for electrically powering the fan 36. These thermoelectric generators 38 are connected together and they are positioned over part or all of a wall 40 between the ventilation space 30 and the secondary air stream passage 28, which wall 40 may also receive a thermal protection coating (not shown in the figures).

In known manner, a thermoelectric generator (also known as a “Seebeck generator”) is a device that converts heat (i.e. a temperature gradient) directly into electricity, by using the Seebeck effect (i.e. by providing a potential difference).

An embodiment of a thermoelectric generator 38 is shown in FIG. 2. Typically, it comprises a plurality of semiconductor elements 42 having thermoelectric properties and respectively subjected to N type and to P type doping, which elements are connected to two conductive plates 44, these conductive plates being covered in respective substrates 46 forming electrical insulation. The conductive plates 44 are also connected to electric terminals 48 that are connected to the fan 36 in order to power it electrically.

The operation of such a thermoelectric generator 38 is itself known and is therefore not described in detail. Briefly, when the two substrates 46 are subjected to a temperature gradient (one of the substrates being positioned in this example beside the secondary air stream passage 28 and the other substrate being positioned beside the ventilation space 30), the flow of heat gives rise to a difference in charge that is sufficient to induce a potential difference that enables electricity to be delivered. The substrate positioned beside the ventilation space 30 forms a first face of the thermoelectric generator. The substrate positioned beside the secondary air stream passage 28 forms a second face of the thermoelectric generator.

FIG. 3 is a diagram showing the operation of such a ventilation circuit after the turbojet has stopped.

Typically, after the turbojet has stopped, the temperature of the high-pressure body of the turbojet (and in particular of the combustion chamber 20) significantly exceeds ambient temperature T_{ambient} that exists inside the secondary air stream passage 28. A large temperature gradient ΔT is thus available between the high-pressure body and the secondary air stream passage.

This temperature gradient ΔT is used as an energy source by the thermoelectric generators 38 in order to induce a potential difference ΔV that is proportional to the temperature gradient ΔT that is used for powering the electric fan 36. The fan thus ventilates the ventilation space 30 so as to establish a forced flow of air through it (the ventilation air is reinjected downstream into the secondary air stream passage 28 via openings 50 that are formed in the wall 40—see FIG. 1). This ventilation thus serves to cool the equipment 32.

With the ventilation space 30 thus being ventilated progressively by the fan 36, the temperature gradient ΔT between the high-pressure body and the secondary air stream passage of the turbojet diminishes accordingly. Since the potential difference ΔV induced by the thermoelectric generators 38 is proportional to the temperature difference ΔT, the electrical energy that is produced also diminishes, thereby reducing the amount of ventilation. The fan 36 thus stops on its own once the temperature gradient ΔT is no longer great enough to induce a potential difference ΔV. At this stage, the equipment 32 present in the ventilation space 30 has been cooled and the ventilation space has reached temperature equilibrium with the secondary air stream passage 28.

As a result, ventilation of the ventilation space is obtained that is self-regulating and that therefore does not require the presence of temperature sensors and a control device (the fan 36 starts and stops on its own), with it being certain that stopping of the fan corresponds to temperature equilibrium between the ventilation space and the secondary air stream passage, which means that such ventilation is no longer required. Furthermore, the ventilation does not require the turbojet to be in operation, nor does it require energy to be supplied from elsewhere.

It should be observed that the operation of the ventilation circuit of the invention is equally valid while the turbojet is in operation (and in particular while it is in flight). When the turbojet is in operation, the temperature gradient ΔT between the primary air stream passage and the secondary air stream passage is likewise available.

It should also be observed that it is possible to stop the operation of the fan 36 before temperature equilibrium is reached between the ventilation space and the secondary air stream passage (i.e. as soon as the temperature inside the ventilation space becomes lower than a predetermined threshold temperature that is higher than the temperature that exists in the secondary air stream passage 28). This operating option makes it possible to limit overuse of the ventilation circuit.

For this purpose, one solution consists in adjusting the starting voltage of the fan so that it stops operating as soon as a determined temperature gradient is reached (i.e. below a potential difference threshold ΔV induced by the thermoelectric generators). Such a solution consists in having recourse to non-controlled switching of the fan power supply. Another solution may be based on an electronic control device for the fan that is not connected to the electronic computer of the engine and that is present in the ventilation space.

In an advantageous provision, the ventilation circuit also includes means for monitoring the operation of the fan 36 in order to detect any malfunction thereof. This monitoring may be performed by an appropriate sensor mounted on the fan or by a temperature sensor already present in the ventilation space.

It should also be observed that the thermoelectric generators 38 may be arranged in redundant manner and/or may be organized to provide a plurality of independent power supply channels for the fan 36, in order to reduce the risk of these generators all malfunctioning together.

Finally, in a variant embodiment that is not shown, the ventilation circuit may also include forced ventilation of a cold zone of the ventilation space provided by the same fan 36. This additional ventilation serves to improve efficiency of the circuit for ventilating the equipment 38 and to avoid a boundary layer forming that is harmful for ventilation between the cold zone and the hot zone of the ventilation space. In practice, this additional ventilation requires the addition of a dedicated fan inside the ventilation space and directed towards its cold zone.

In another variant embodiment that is not shown, provision may be made for forced ventilation of the second face of the thermoelectric generator 38, i.e. the face that is positioned beside the secondary air stream passage 28, using the cold air taken from said passage in the cold zone Z_{F} of the turbine engine. For example, cold air may be taken by at least one scoop followed by an auxiliary fan circuit in which a fan is arranged so as to direct the air that is taken in to an air duct of the auxiliary circuit, the air duct leading to at least one ventilation nozzle directed towards the second face of the generator.

The air duct is installed in full or in part in the space situated between the secondary air stream passage and the primary air stream passage. The fan of the auxiliary ventilation circuit may be the fan 36 for cooling the ventilation space, or it may be a fan that is independent of the fan 36. It is powered electrically by the thermoelectric generator 38 or by another thermoelectric generator 38, so that the ventilation nozzles blow cold air against the second face of the thermoelectric generator, which cold air is delivered by the air duct, at least after the turbine engine has stopped.

By way of example, the ventilation nozzles may all be installed upstream from the second face of the generator so as to blow cold air towards the downstream end of the secondary air stream passage. By way of example, they may form part of a diffuser that extends in the circumferential direction over the wall 40 between the ventilation space 30 and the secondary air stream passage 28. The diffuser may be of a shape that fits closely to the wall 40 in the circumferential direction, so that the outside surface of the diffuser is flush and a little above the outside surface of the wall 40, and does not significantly disturb the flow of air in the secondary air stream passage during stages of flight.

In this way, after the turbine engine has stopped, the second face of the generator is cooled sufficiently to maintain the potential difference ΔV induced by the temperature difference between the first and second faces of the thermoelectric generator at a level that is sufficient. This ensures a power supply voltage for the electric fans that is sufficient.

1. A method for the ventilation of equipment of a turbojet, the turbojet having a cold zone including a fan upstream from a hot zone, the turbojet equipment intended to be ventilated being arranged in a ventilation space available around the hot zone between a primary air stream passage and a secondary air stream passage of the turbojet, the method comprising taking ventilation air from one of the air stream passages in order to convey it to the ventilation space, and providing forced flow of the ventilation air by means of at least one electric fan positioned inside the ventilation space and powered electrically by at least one thermoelectric generator suitable for inducing a potential difference and positioned inside a wall separating the ventilation space from the secondary air stream passage, said electric fan being electrically powered at least after the turbojet has stopped, a first face of the thermoelectric generator being positioned beside the ventilation space so as to be cooled by the ventilation air, the operation of the fan being self-regulating, such that the fan stops operating when the cooling of the first face of the thermoelectric generator by the ventilation air has caused said potential difference to become less than a predetermined voltage threshold.

2. A method according to claim 1, wherein the electric fan is permanently connected to electric terminals of the thermoelectric generator.

3. A method according to claim 1, wherein said voltage threshold is predetermined by determining a starting voltage of the fan so that the fan ceases to operate as soon as the potential difference induced by the thermoelectric generator becomes less than the starting voltage threshold.

4. A method according to claim 1, wherein the operation of the electric fan is monitored in order to detect any malfunction.

5. A method according to claim 1, wherein the electric fan is electrically powered during at least one stage of operation of the turbojet.

6. A ventilation circuit for equipment of a turbojet, the turbojet having a cold zone including a fan upstream from a hot zone, the turbojet equipment intended to be ventilated being arranged in a ventilation space available around the hot zone between a primary air stream passage and a secondary air stream passage of the turbojet, the circuit comprising means for taking ventilation air from one of the air stream passages and for conveying it to the ventilation space, and at least one electric fan positioned inside the ventilation space and powered electrically by at least one thermoelectric generator suitable for inducing a potential difference and positioned inside a wall separating the ventilation space from the secondary air stream passage, a first face of the thermoelectric generator being positioned beside the ventilation space so as to be cooled by the ventilation air.

7. A ventilation circuit according to claim 6, wherein the fan possesses a starting voltage threshold that is predetermined so that the fan ceases to operate as soon as the potential difference induced by the thermoelectric generator becomes less than the starting voltage threshold.

8. A ventilation circuit according to claim 6, further including means for detecting possible malfunction of the fan.

9. A ventilation circuit according to claim 6, wherein each thermoelectric generator comprises a plurality of semiconductor elements having thermoelectric properties and connected to two conductive plates, each plate being covered in a substrate forming electrical insulation, one of the substrates being placed beside the secondary air stream passage, and the other substrate being placed beside the ventilation space.

10. A ventilation circuit according to claim 6, wherein the thermoelectric generator has a second face positioned beside the secondary air stream passage, the circuit including an auxiliary ventilation circuit adapted to ventilate said second face with cold air taken from said secondary air stream passage beside the cold zone of the turbojet.

11. A ventilation circuit according to claim 10, wherein a fan is arranged in such a manner as to convey the cold air that has been taken to an air duct of the auxiliary circuit, said air outlet leading to at least one ventilation nozzle pointing towards the second face of the thermoelectric generator, said fan being constituted by the electric fan of the ventilation space or by another electric fan also powered electrically by a thermoelectric generator.

12. A turbojet including a ventilation circuit according to claim 6.
